(19) United States
(12) Patent Application Publication
(10) Pub. No.: US 2006/0249294 A1
(43) Pub. Date: Nov. 9, 2006

(54) Device for tightening threaded fastener joints

(75) Inventors: Phillip Lee Klingler, Bryan, OH (US); Nicholas Andrew Ihnat, Twinsburg, OH (US); Michael Murray Starick, Chardon, OH (US); Frank Joseph Lebar, Brecksville, OH (US)

Correspondence Address: Robert V. Vickers, Esq.;Fay, Sharpe, Fagan, Minnich & McKee, LLP, Seventh Floor, 1100 Superior Avenue, Cleveland, OH, 44114-2579, US

(73) Assignee: Jergens, Inc.

(21) Appl. No.: 11/287,171

(22) Filed: Nov. 23, 2005

Related U.S. Application Data
(60) Provisional application No. 60/678,637, filed on May 6, 2005.

(51) Int. Cl. B23Q 5/00

(52) U.S. Cl. 173/178

(57) ABSTRACT

A fastener joint tightening apparatus with an inertia canceling unit is disclosed for tightening a threaded fastener joint using a power tool driven by an electric motor, including a tool adapter for engaging a rotating member of the tool, a bit adapter for engaging a bit for tightening a threaded fastener, and a torsional spring mounted between the tool and bit adapters to dampen torsional torque during fastener tightening.

### REFERENCE TO RELATED APPLICATION

This application claims priority to and the benefit of U.S. Provisional Patent Application Ser. No. 60/678,637, which was filed May 6, 2005, entitled DEVICE FOR TIGHTENING THREADED FASTENER JOINTS, the entirety of which is hereby incorporated by reference.

### FIELD OF THE INVENTION

The present invention relates generally to tightening joints using threaded fasteners and more particularly to tightening devices and inertial canceling units for electric power tools.

### INCORPORATION BY REFERENCE

Tools for tightening threaded fasteners and related technology are set forth in the following U.S. patents, incorporated herein by reference as background material: Rice U.S. Pat. No. 4,106,176; Eshghy U.S. Pat. No. 4,228,576; Eshghy U.S. Pat. No. 4,305,471; Finkelston U.S. Pat. No. 4,344,216; Ney U.S. Pat. No. 4,375,123; McIntosh U.S. Pat. No. 4,959,797; Eshghy U.S. Pat. No. 5,131,130; Soshin U.S. Pat. No. 5,154,242; Hansson U.S. Pat. No. 5,205,031; Udocon U.S. Pat. No. 5,215,270; Whitehouse U.S. Pat. No. 5,315,501; Kainec U.S. Pat. No. 5,637,968; Strauch U.S. Pat. No. 5,704,261; Cooper U.S. Pat. No. 5,845,718; Cooper U.S. Pat. No. 5,848,655; Reckelhoff U.S. Pat. No. 5,988,026; Bookshar U.S. Pat. No. 6,516,896; and Hansson U.S. Pat. No. 6,758,591.

### BACKGROUND OF THE INVENTION

Threaded fasteners are used in a multitude of products to join two or more component structures into a rigid part referred to as a joint, in which the joint is tightened by rotating a threaded fastener relative to a stationary threaded surface. Such fasteners include male and female threaded members, for example, a nut and a bolt, a bolt and an internally threaded hole of a joint part, a threaded stud and a nut, etc. Self threading fasteners may also be used, where the bolt or screw is rotated and advanced toward a workpiece hole with the threads on the fastener creating threads in the workpiece hole as the fastener advances. In a common situation, a bolt or screw is rotated in a clockwise direction using a tool with a bit having an interface structure adapted to rotatably engage the fastener. The rotation of the fastener advances the fastener, thereby joining the component parts. In a mass production assembly line application, such threaded fastener joints are typically tightened using electric power tools to cause rotation of the fastener, wherein manufacturing specifications require a specific rotational tightening torque for a given fastener joint.

Difficulties often arise in controlling the amount of torque applied to fasteners in a manufacturing setting. In the case of electric power tool systems for fastener joint tightening, an electric motor is provided with a rotating output shaft connected through a transmission for reducing speed and increasing torque, to an output head or other rotating structure. A fastener adapter or bit is mounted in the rotating structure for applying torque to a threaded fastener. In many systems, the motor is controlled according to torque and/or angle in a closed-loop fashion, with the goal being to tighten the joint to a desired or set point torque and then to shut off the motor or otherwise discontinue the driving action. The control system may include a torque transducer providing torque feedback signals to a microprocessor or other controller operating the motor, or alternatively the motor current may be monitored to ascertain the amount of applied torque during tightening. The torque feedback signal or estimate is continuously compared to the torque set point value, and the application of power to the motor is ceased when the set point has been reached. Ideally, the joint tightening system is calibrated and tuned to achieve repeatable, consistent, automated application of torque to a large number of joints in a minimal amount of time in an assembly process without human intervention. In practice, however, it is impossible to immediately terminate application of rotational torque to the fastener when the set point is attained, due to mechanical inertia of the tool motor, the gearing, etc. The inability to quickly stop mechanical rotation of the system often leads to provision of excess torque to the joint, referred to as overshoot, in which case the actual applied torque may be much higher than the set point torque and may even exceed the acceptable maximum torque allowed under manufacturing specifications. Moreover, inaccuracies and/or noise in the torque feedback signal cause deviation, variability, and scatter relative to the desired torque values.

In addition, automated application of torque is complicated by variations in workpiece and fastener dimensions, materials, and by the presence or absence of washers or other intervening structures in the joint. In this regard, different workpiece joints respond very differently to applied fastener torque. A workpiece joint may be characterized according to a joint rate, which is the amount of torque required to turn or rotate the fastener one angular degree. In a joint consisting of two relatively flat incompressible workpieces with no washers, for example, the applied torque or motor current remains fairly low while the fastener is initially threaded in (known as a free-running torque value), and then ramps up very quickly as the fastener head engages the workpiece and compresses the joint. This type of joint is referred to as a “hard joint”, and has a relatively high joint rate after the free-running torque range. On a high torque rate threaded joint, the torque can easily exceed the upper acceptable value of a specified torque range (overshoot), due to the inability to quickly stop the tool, since the torque rises at a very high rate (e.g., steep slope on a torque vs. time curve). Conversely, so-called “soft joints” are found where one or more compressible washers are employed in a faster joint and/or where the workpieces themselves are somewhat elastic, in which case the applied torque rate is relatively low (e.g., the torque rises more slowly per degree of angular rotation). The slower joint rate for medium and soft joints allows more time for the tool motor and gearing to be stopped upon reaching the set point torque, whereby overshoot is less of a problem for soft joints. Thus, for a given tool motor speed and set point torque, hard joints will be tightened faster than soft joints, but hard joints will typically have much worse torque overshoot.

In joint fastening systems generally, it is desirable to provide tools that can be used on both hard and soft joints. In an automated factory setting, for example, universally applicable power tools are preferred because fewer tools are needed to tighten different joint types. In this regard, manufacturers want assembly line workers to be able to select from a small number of tools based on torque range rather than having to further differentiate based on joint types or the joint rate for a given joint. Automated power tools are therefore evaluated with respect to capability of controlling torque on a combined series of threaded fastener joints of widely differing torque rates with a minimum of user involvement and complexity. Ideally, an assembler can use a single power tool to tighten fasteners in a given required torque range, even where some joints are hard joints and some are soft.

Several advances have been developed to combat hard joint torque overshoot. One approach is to begin shutting off the motor prior to actually reaching the desired torque value, as discussed in Whitehouse U.S. Pat. No. 5,315,501, incorporated herein by reference. The shutoff point may be determined based on various factors, such as measured or predicted torque rate, the amount of actual overshoot based on empirical measurements, the deceleration time for a given tool motor and gearing combination, etc. However, the amount of overshoot in very hard joints has been found to vary widely, wherein such anticipatory shut-off approaches do not provide the consistency required in many applications. Another technique for reducing overshoot is to simply slow the motor speed for hard joints. This, however, forces an operator to identify in advance whether a particular fastener joint is hard or soft, and also significantly lengthens cycle time. Yet another approach to minimizing hard joint overshoot involves slowing the tool motor speed at an intermediate torque value prior to reaching the set point, as described in Kainec U.S. Pat. No. 5,637,968 and Bookshar U.S. Pat. No. 6,516,896. In one example, a predetermined torque value is programmed in the motor controller (e.g., above the free-running torque level), at which the speed is lowered to a specified downshift speed value. This downshift feature may be used on all joints, or the joint rate may be measured or calculated in real time, with the speed being lowered only for hard joints. In either case, the slowed motor speed leads to increased cycle time for hard joints, and the downshift technique may only reduce the amount of torque overshoot attributable to excess rotation of the tool motor caused by inertia in the decelerating high-speed elements in the tool. Furthermore, such advanced control techniques require more expensive control equipment and operator skill than do tools with a single setpoint torque and speed setting. Thus, there remains a need for improved threaded fastener joint tightening apparatus by which torque overshoot can be mitigated for hard joints, while achieving uniform consistent acceptable torque values for both hard and soft joints without unduly lengthening cycle times.

### SUMMARY OF INVENTION

A summary of one or more aspects of the invention is now presented to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The invention relates to torque controlling devices and inertia canceling drive units therefor for tightening threaded fastener joints using electric power tools driven by an electric motor. The device can be used to improve joint tightening performance for any type of electric power tool with a rotating output, and is applicable in conjunction with any type of fasteners, wherein the drive unit operates to dampen or absorb peak torque provided by a power tool prior to final mechanical shut down, to avoid overtightening hard joints and the variability associated with torque overshoot. In this manner, the apparatus can be employed without downshifting or other more complicated control strategies previous developed, thereby facilitating use of a single tool for hard and soft joints without significantly increasing the cycle times for hard joints. Moreover, the invention requires no adjustments or other human intervention to tighten a series of mechanical threaded fastener joints of various joint rates to achieve uniform consistent torque values using simple controls and tools.

In one aspect of the invention, a tightening device and an inertia canceling drive unit therefor is provided, which comprises a tool adapter for engaging a rotating member of a power tool, a bit adapter for engaging a bit for tightening a threaded fastener, and a torsional spring mounted between the tool and bit adapters to dampen torsional torque during fastener tightening. The tool adapter in one embodiment extends along an axis between first and second opposite tool adapter end members, with the first end member being shaped or otherwise configured to engage a rotating member the power tool. The bit adapter has a first end member spaced from and facing the second tool adapter end member, as well as a second end member configured to engage a bit for tightening the fastener. The spring comprises axially opposite first and second end members and a coil extending along the axis therebetween, with the first spring end member being attached to the tool adapter and the second spring end member being attached to the bit adapter. In joint tightening operations, the coil dampens torque applied between the tool adapter and the bit adapter, by which hard joint torque overshoot can be reduced or eliminated. Furthermore, the use of the inertia canceling unit allows a single tool assembly and simple tool controller to be used for both hard and soft joints with the same tool speed, whereby joint cycle times for hard joints are not appreciably increased, as was the case using conventional downshifting techniques.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages and novel features of the invention will become apparent from the following detailed description of the invention when considered in conjunction with the drawings, in which:

FIG. 1 is a side elevation view partially in section illustrating a joint fastening system with an inertia canceling unit for tightening threaded fastener joints using an electric power tool driven by an electric motor in accordance with one or more aspects of the present invention;

FIG. 2 is a graph showing torque vs. time curves for hard and soft joints with a single set point torque value, in which a soft joint and a hard joint are illustrated at different first and second speeds with the same starting time, along with a curve showing a hard joint at the second speed and a curve showing the hard joint at the second speed using the compliant drive inertia canceling unit of the invention;

FIG. 3 is a graph showing torque vs. time curves for hard and soft joints with a single set point torque value, in which a soft joint and a hard joint are illustrated at different first and second speeds, along with a curve showing a hard joint at the second speed, with the same starting time;

FIG. 4 is a graph showing torque vs. time curves for hard and soft joints with a single set point torque value, in which a soft joint and a hard joint are illustrated at different first and second speeds, as well as a curve showing a hard joint at the second speed, with a common finishing time; and

FIG. 5 is a table showing exemplary final torque value results at a first motor speed for soft and hard joints with no inertia canceling unit, and for hard joints using the inertia canceling unit of the invention at the same first motor speed.

### DETAILED DESCRIPTION OF THE INVENTION

The present invention relates to threaded fastener joint tightening apparatus and inertia canceling units therefor. One or more exemplary implementations of the present invention are hereinafter illustrated and described, wherein like reference numerals are used to refer to like elements throughout and wherein the illustrated structures are not necessarily drawn to scale.

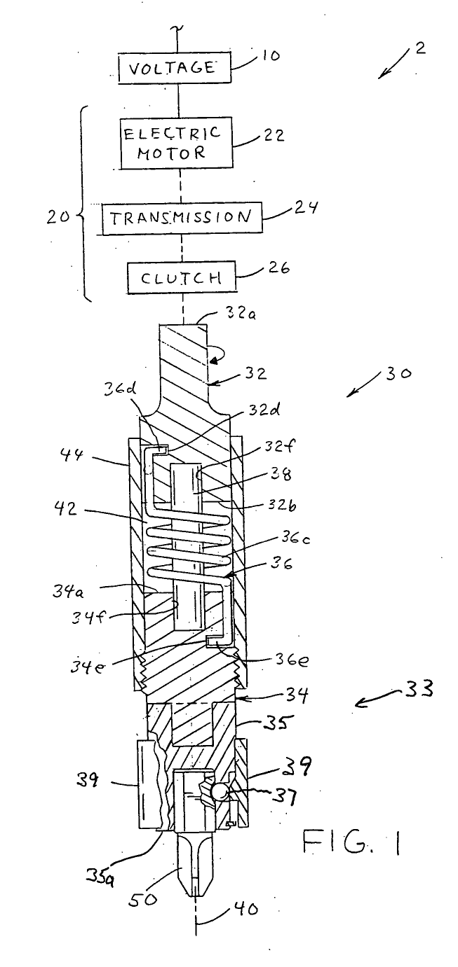

FIG. 1 illustrates an exemplary threaded fastener joint tightening system 2 including an electric power tool 20 with a transmission 24 and a clutch 26 driven by an electric motor 22 according to a voltage from a control system 10, where a rotary output of tool 20 is coupled to a inertia canceling unit or inertia canceling drive unit 30 for application of rotational torque to tighten a threaded fastener (not shown) in accordance with one or more aspects of the invention, wherein tool 20 and unit 30 provide a tightening device and controller 10 provides a inertia canceling feedback unit for driving the tightening device 20, 30. System 2 may be any form or type of rotary joint tightening apparatus operational to apply torque to a threaded fastener in a controlled fashion, for example, a lightweight electric screw driver system for assembly of electronic products, automotive interior components, or other applications requiring fastener torques in the range of tens of pound inches or less, having a brushless motor 22 controlled in closed loop fashion according to torque and/or angle, with goal being to tighten the joint to a desired or set point torque and then to shut off motor 22. Control system 10 ascertains applied torque in real time by monitoring current applied to motor 22, although a torque transducer (not shown) may optionally be provided within transmission 24 to provide a torque feedback signal to a microprocessor in controller 10. The torque feedback signal, whether from a transducer or derived from current, is compared during tightening to the set point or desired torque value, and the voltage applied to motor 22 is discontinued or lowered when the set point is reached. The exemplary system 2 and controller 10 thereof may, but need not employ adaptive control algorithms and downshifting for special control treatment of hard joints, wherein the employment of the inertia canceling unit 30 facilitates simple single speed operation of tool 20 for both hard and soft joints.

Inertia canceling unit 30 includes a tool adapter or shank 32 extending along an axis 40 between first and second opposite tool adapter end members 32a and 32b, respectively, wherein first end member 32a has a hexagonal or rectangular exterior shape or profile configured to engage a rotating member of tool 20. Other implementations are possible, wherein first tool adapter end member 32a includes a shaped recess or socket adapted to receive and rotatably engage a hexagonal or rectangular member at the rotary output of tool 20, or wherein unit 30 may be other wise releasably or fixedly attached to tool 20.

Unit 30 further includes a bit adapter 33 with a first bit adapter structure 34 and a second bit adapter structure 35, where the bit adapter 33 extends along axis 40 from a first end member 34a of structure 34 to a second end member 35a of structure 35, where first end member 34a is spaced from and faces tool adapter 32. Adapter 32 and member 34 are mounted within a cavity 42 of a tubular housing 44, with adapter 32 being press fit within inner walls of an upper end of housing 44 and a lower end of the inner wall of housing 44 includes threads for threadingly engaging mating threads on outer surface of structure 34. Structures 34 and 35 are press fit together and may be joined by any suitable manner that does not allow relative rotation thereof, where structure 35 may be made of any suitable material, such as a magnetic material ion one embodiment.

In the illustrated example, moreover, second end member 35a of bit adapter 33 is shaped or otherwise configured to engage or otherwise be releasably mounted to a fastener bit 50 that engages a threaded fastener (not shown) for tightening a fastener joint. In the illustrated embodiment, adapter end member 35a includes a hexagonal recess for receiving standard tool driver bits for standard or Phillips head screws, sockets for driving hex head bolts, etc., although any suitable bit interface may be provided, or second end member 35a may include a fixed bit, wherein all such implementations are contemplated as falling within the scope of the invention and the appended claims. The recess of member 35a in one example includes a spring loaded ball 37 with a slidable outer ring sleeve 39 for selectively releasing bit 50 from bit adapter 33.

In accordance with one or more aspects of the invention, unit 30 includes a torsional spring 36 mounted to adapter 32 and structure 34 and extending within cavity 42 of housing 44 for absorbing or dampening torsional torque. Spring 36 includes axially opposite first and second spring end members 36a and 36b, respectively, and a coil 36c extending along (e.g., radially disposed about) axis 40, where first end member 36a is attached to tool adapter 32 at end member 32b via a radially inwardly facing bend portion 36d of spring end member 36a extending within a corresponding cavity or channel 32d within second end member 32b of tool adapter 32. Similarly, second spring end member 36b includes a radially inwardly facing bend portion 36e extending within a corresponding cavity 34e within first end member 34a of bit adapter 33, wherein spring 36 and coil 36c thereof is tensioned or biased to inhibit axial movement of bit adapter 33 away from tool adapter 32. Spring 36 may be fashioned from stainless steel or other suitable metal or non-metal spring materials, wherein the amount of preload tension and spring constant, as well as torsional dampening characteristics may be selected according to torque ranges over which unit 30 is to be operated, such that coil 36c provides dampening of torque applied between tool adapter 32 and bit adapter 33. Unit 30 further comprises a support member 38 extending along axis 40 between corresponding cavities 32f and 34f in adapter 32 and structure 34, respectively, wherein support member 38 limits axial movement of bit adapter 32 toward tool adapter 33. The threaded engagement of housing 44 and structure 34 allows disassembly for changing torsional spring 36.

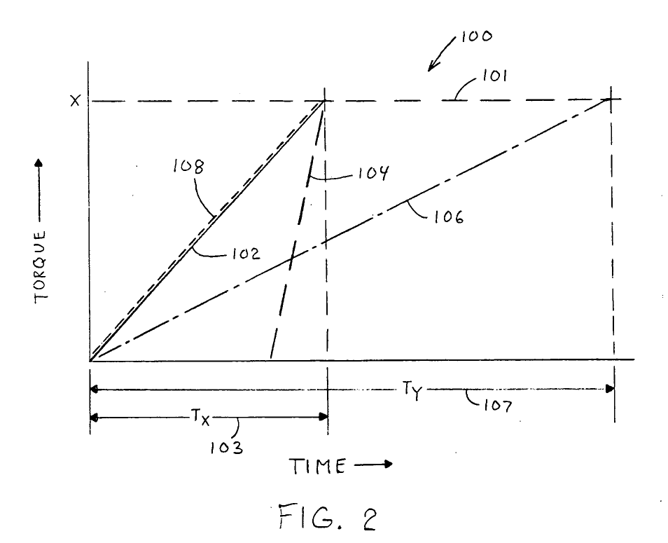

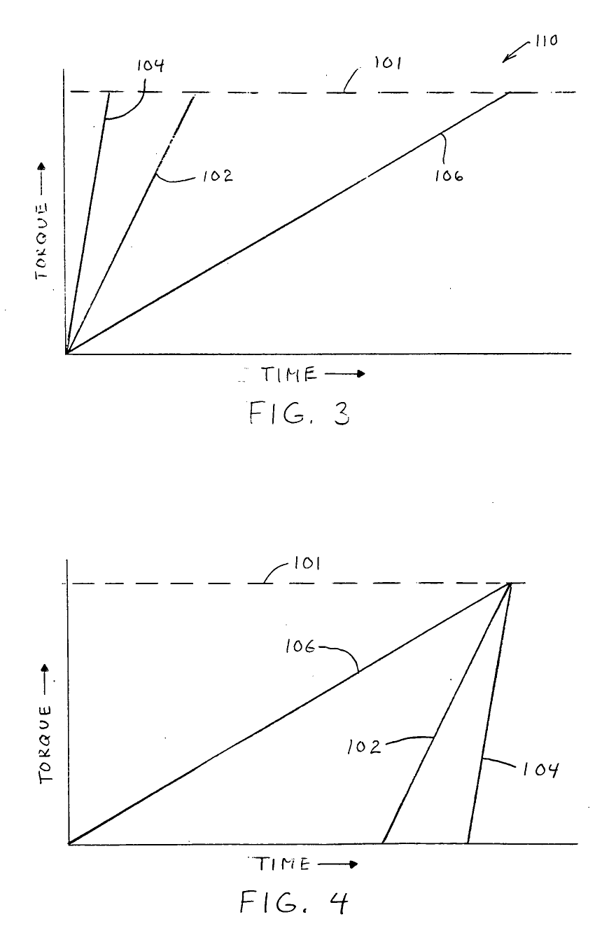

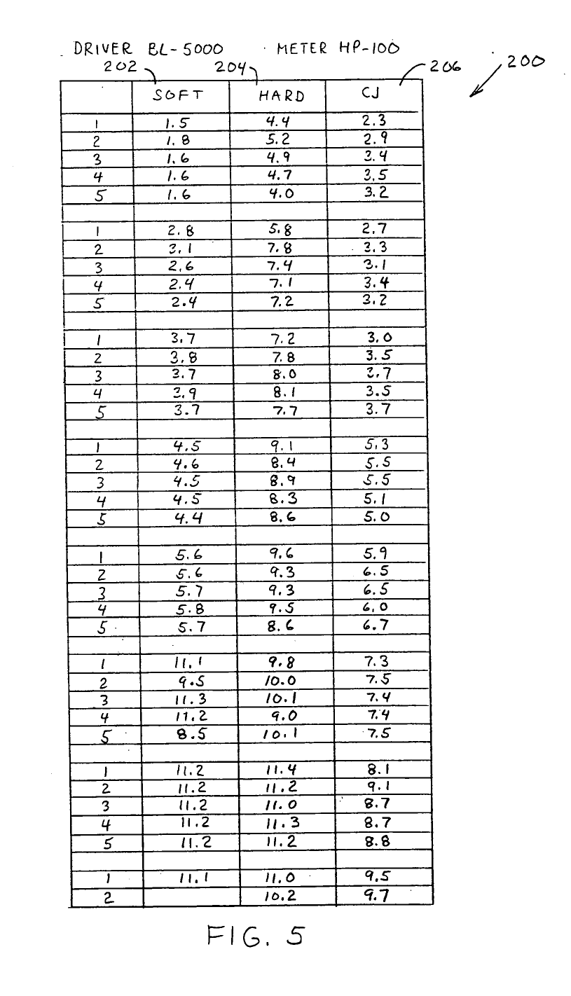

FIGS. 2-4 include graphs 100, 110, and 120, respectively, showing torque vs. time curves 102, 104, 106, and 108 corresponding to various exemplary hard and soft joints, where the same final set point or desired torque value X 101 is used for the curves 102-108 and the joints tested. Curve 102 illustrates a soft joint at a motor speed of 1000 rpm without the unit 30 (e.g., tool 20 having bit 50 installed directly thereon), wherein the soft joint cycle time 103 T_{X} in graph 100 is relatively short but longer than for a hard joint at the same speed. Curve 104 shows the hard joint torque vs. time curve for a motor speed of 1000 rpm, also without the unit 30 and without downshifting. As can be seen in graphs 100, 110, and 120, the cycle time for the full speed hard joint tightening is very short, although subject to high amounts of torque overshoot and variability in final torque values. Curve 106 shows the same hard joint with motor 22 operated at only 100 rpm. As discussed above, while this approach may attenuate the amount of torque overshoot, the resulting cycle time T_{Y} 107 (FIG. 2) is unacceptably long, and therefore undesirable in a factory automation setting. Curve 108 in FIG. 2 illustrates the performance of the tightening system 2 using the inertia canceling unit 30 of FIG. 1 for the same hard joint at the high motor speed of 1000 rpm. As can be seen in the graph 100, curve 108 essentially tracks the soft joint response in curve 102 for a soft joint using the same speed and torque set point values, whereby the invention facilitates tightening hard joints at higher speeds (e.g., with much shorter cycle times 103) that are obtainable using simple speed reduction. Moreover, as seen in curves 102 and 108, the cycle time 103 for the speed of 1000 rpm is basically the same for both hard and soft joints.

FIG. 5 illustrates a table 200 of comparative torque result values in columns 202, 204, and 206 (in pound foot inches) obtained for 5 test runs each at various set point torque values for a soft joint (column 202, also curve 102 in FIGS. 2-4) at a first motor speed of 1000 rpm without the unit 30, for a hard joint (column 204 and curve 104 in FIGS. 2-4) at 1000 rpm, and for the same hard joint at 1000 rpm using the inertia canceling unit 30 (column 206 in FIG. 5 and curve 108 of FIG. 2). Comparing data from columns 202 and 204, it is seen that absent use of the unit 30 of the invention or other advanced control techniques, the final torque values (column 204) have much higher levels of overshoot, whereas the soft joint values (column 202) are fairly repeatable with little scatter or deviation. Also comparing column 206 (e.g., hard joint with unit 30), the hard joint torque values using unit 30 are much more stable and close to the soft joint values, wherein the unit 30 operates to dampen the applied torsional torque at the critical shutoff portion of each tightening cycle, thereby significantly reducing torque overshoot. Thus, the invention advantageously facilitates reduction in hard joint torque overshoot (FIG. 5), while achieving hard joint cycle times (e.g., time 103 in FIG. 2) commensurate with those of soft joints. In this regard, it is noted that assembly line tool operators need not make any adjustments between hard and soft joints by the operation of unit 30, and moreover, will not detect any appreciable difference in cycle times in tightening a series of joints of various joint rates. Moreover, the unit 30 can be employed in any joint tightening system, including electric power tool systems 2, air tool systems, hand tools, etc.

The invention has been illustrated and described with respect to one or more exemplary implementations or embodiments. However, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

1. A drive unit for tightening a threaded fastener joint using an electric power tool driven by an electric motor, said unit comprising:
a tool adapter extending along an axis between first and second opposite tool adapter end members, said first tool adapter end member being configured to engage a rotating member of an electric power tool;
a bit adapter extending along said axis between first and second opposite bit adapter end members, said first bit adapter end member facing said second tool adapter end member and being spaced therefrom, said second bit adapter end member being configured to engage a bit for tightening a threaded fastener; and
a torsional spring comprising axially opposite first and second spring end members and a coil extending along said axis between said first and second spring end members, said first spring end member being attached to said second tool adapter end member, said second spring end member being attached to said first bit adapter end member, said coil dampening torsional torque applied between said tool adapter and said bit adapter.

2. A unit as defined in claim 1, further comprising a support member extending along said axis between said first bit adapter end member and said second tool adapter end member, said support member limiting axial movement of first said bit adapter end member toward said second tool adapter end member.

3. A unit as defined in claim 2, further comprising a housing structure having at least one sidewall disposed from said axis, said sidewall extending between first and second housing end members and defining an interior cavity extending along said axis, wherein said tool adapter and said bit adapter are mounted to said housing at least partially within said cavity, said tool adapted being mounted at said first housing end member and said bit adapted being mounted at said second housing end member.

4. A unit as defined in claim 1, further comprising a housing structure having at least one sidewall disposed from said axis, said sidewall extending between first and second housing end members and defining an interior cavity extending along said axis, wherein said tool adapter and said bit adapter are mounted to said housing at least partially within said cavity, said tool adapted being mounted at said first housing end member and said bit adapted being mounted at said second housing end member.

5. A unit as defined in claim 4, wherein said spring is biased so as to inhibit axial movement of first said bit adapter end member away from said second tool adapter end member.

6. A unit as defined in claim 3, wherein said spring is biased so as to inhibit axial movement of first said bit adapter end member away from said second tool adapter end member.

7. A unit as defined in claim 2, wherein said spring is biased so as to inhibit axial movement of first said bit adapter end member away from said second tool adapter end member.

8. A unit as defined in claim 1, wherein said spring is biased so as to inhibit axial movement of first said bit adapter end member away from said second tool adapter end member.

9. An inertia canceling unit for tightening a threaded fastener joint with a power tool, said unit having an inertia canceling drive unit comprising:
a tool adapter extending along an axis between first and second opposite tool adapter end members, said first end member being configured to engage a rotating member of the power tool;
a bit adapter extending along said axis between first and second opposite bit adapter end members, said first bit adapter end member facing said second tool adapter end member and being spaced therefrom, said second bit adapter end being configured to engage a bit for tightening a threaded fastener; and
a torsional spring comprising axially opposite first and second spring end members and a coil extending along said axis between said first and second spring end members, said first spring end member being attached to said second tool adapter end member, said second spring end member being attached to said first bit adapter end member, said coil dampening torsional torque applied between said tool adapter and said bit adapter.

10. An inertia canceling drive unit as defined in claim 9.

11. A torque feedback unit for driving said tightening device as defined in claim 9 between from low torque to a set maximum torque value.
